(19) United States
(12) Patent Application Publication
(10) Pub. No.: US 2011/0086430 A1
(43) Pub. Date: Apr. 14, 2011

(54) METHOD AND DEVICE FOR ISOTOPIC RATIO ANALYSIS

(75) Inventors: Michael Krummen, Oldenburg (DE); Johannes Schwieters, Ganderkesee (DE); Jens Griep - Raming, Ganderkesee (DE)

(73) Assignee: THERMO FISHER SCIENTIFIC (BREMEN) GMBH, Bremen (DE)

(21) Appl. No.: 12/742,368

(22) PCT Filed: Nov. 10, 2008
(86) PCT No.: PCT/EP2008/009474

§ 371 Date: Dec. 6, 2010

(30) Foreign Application Priority Data
Nov. 13, 2007 (DE) 10 2007 054 420.2

(51) Int. Cl. G01N 30/02; G01N 30/84; G01N 1/44

(52) U.S. Cl. 436/161; 73/61.55; 73/23.41

(57) ABSTRACT

A process and an apparatus for isotope ratio analysis, the process having the following steps: performing a liquid chromatography process and thus providing an eluate which comprises at least one liquid carrier fluid and at least one analytes, collecting a portion of interest from the eluate, processing the eluate portion to form at least one gaseous conversion products of the analytes, and supplying the gaseous conversion products, especially with gaseous carrier fluid, to an isotope analyzer and determining the isotrope ratios.

### BACKGROUND OF THE INVENTION

1. Technical Field

The invention relates to a process and to an apparatus for isotope ratio analysis. The term “isotope ratio analysis” preferably also includes the analysis of only one isotope.

2. Prior Art

To perform isotope ratio analysis, high-precision isotope analyzers are used, for example specific mass spectrometers (IRMS), laser absorption measurement devices, optical detectors or other suitable analyzers or isotope-selective detectors. Generally gaseous substances have to be supplied to the analyzers. Special features therefore have to be taken into account in the analysis of liquids or solids. The latter can be provided, for example, as a mixture via a liquid chromatograph (LC or HPLC). In the liquid chromatograph, the substances dissolved in the liquid are separated in terms of time. Liquid chromatography is applied, inter alia, to substances which contain carbon, nitrogen, oxygen, hydrogen and/or sulfur. To determine the isotope ratio of the elements mentioned, a conversion of the substances (analytes) to gaseous conversion products is required. Suitable (simple or stable) gases are typically at least H₂, CO, CO₂, N₂, Cl₂, HCl, CH₄ and SO₂. Further gases are possible.

The coupling of a liquid chromatograph to an IRMS is, for example, known from DE 102 16 975. According to the process described there, gas is obtained from the eluate of a liquid chromatograph in the presence of the eluate. The analysis substances dissolved in the eluate are converted to the gas. Subsequently, the gas is separated from the eluate and supplied to the IRMS.

A special feature is also isotope ratio analysis on the basis of liquid organic samples, for example to determine the carbon isotopes 13C and 12C. Suitable processes for taking account of the carbon present in an analysis substance from soluble compounds or only from organic compounds are disclosed in DE 10 2004 010 969.

DE 10 2005 049 152 discloses subjecting the eluate of a liquid chromatograph to an electrolysis to form and provide a gaseous substance or a precursor for a substance which can be analyzed by an IRMS.

Finally, it is known that liquid or solid samples can be converted by pyrolysis or oxidation in what is known as an element analyzer, thus providing constituents of interest in gaseous form for an isotope analysis. Such an element analyzer is, for example, the Finnigan TC/EA from Thermo Electron Corporation, now being known as Thermo Fisher Scientific.

A common feature of the known processes is that the provision of the gaseous substance for the isotope analysis cannot be performed in any desired manner. At least for reasons of cost and measurement technology, the gaseous substances can be formed only from particular eluates. Such ideal eluates are frequently not available. This is especially true in the determination of isotope ratios in pharmaceuticals, pesticides, food additives and other substances which contain relatively large molecules.

From the point of view of the user, there often exist a wide range of analysis devices for qualitative determination of substances. These also include high-performance liquid chromatographs (HPLC), which can additionally be tuned to specific substances. Such a specific HPLC system is known from Analytical Chemistry, 1998, vol. 70, 409-414, Gillian P. McMahon and Mary T. Kelly “Determination of Aspirin and Salicylic Acid in Human Plasma by Column-Switching Liquid Chromatography Using On-Line Solid-Phase Extraction”. What is disclosed is an HPLC in which an injected sample is first entrained by a solvent and conducted through a first column. Subsequently, a portion of the sample is discharged from the first column by a mobile phase and conducted through a second column. The eluate of the second column is passed through a UV detector and analyzed there. Owing to the solvent present, the eluate is unsuitable for immediate conversion to a gas suitable for isotope analysis. In this case, the user will have to adjust the HPLC process for analysis of aspirin and salicylic acid to the particular features of the isotope analysis. The present invention starts from this point in particular.

### BRIEF SUMMARY OF THE INVENTION

The aim of the present invention is the provision of a process and of an apparatus, such that the user can retain the established LC process (especially HPLC process), and an isotope ratio analysis is possible at the same time. For this purpose, the process according to the invention has the following steps:
a) performing an LC process and thus providing an eluate which comprises at least one liquid carrier fluid and one or more analytes,
b) collecting a portion of interest from the eluate,
c) processing the eluate portion to form one or more gaseous conversion products of the analytes,
d) supplying the gaseous conversion products, especially with gaseous carrier fluid, to an isotope analyzer and preferably determining the isotope ratios therein.

Of the eluate from the LC, only the part of interest is collected, i.e. “cut out”. This eluate portion arrives more particularly at a substrate which may be of significance as a carrier of the eluate portion in the further processing thereof. Optionally, it is first possible for the eluate portions of interest to be collected and stored several times in succession. This allows greater amounts to be processed.

Advantageously, the processing of the eluate portion involves evaporation of the carrier fluid or conversion thereof to gaseous fragments. More particularly, the portion of the eluate portion which has not been evaporated and not been converted to gaseous fragments is combusted—oxidized or pyrolyzed—to form gaseous conversion products. The evaporation and/or combustion is preferably effected on the substrate. The evaporation can be effected by heating the substrate, by means of laser or in some other way.

According to a further concept of the invention, it is envisaged that the evaporation or conversion of the carrier fluid is effected by at least one of the following steps:
a) heating the eluate portion,
b) laser action,
c) resonant energy injection by means of electromagnetic radiation,
d) non-resonant energy injection by means of electromagnetic radiation,
e) chemically selective conversion.

The carrier fluid or solvent used is, for example, methanol, ethanol, acetonitrile, water or a mixture of solvents. The relatively volatile mobile phase formed in this way is preferably separated from the rest of the eluate portion by evaporation. The evaporation can be accomplished, for example, by heating, by the action of a laser, by microwave heating or selective heating of the solvent by resonant irradiation at one wavelength. This brings the eluate portion to a temperature at which the solvent evaporates, but not the analytes to be analyzed.

It is also possible to evaporate the solvent with or without increasing the temperature by a selective chemical reaction, for example by means of an etching gas (chemical etching). Such a chemically selective conversion is known from other fields, for instance from the semiconductor industry and the production or modification of organic films by means of chemical reactions.

Also possible is spatially resolved evaporation with a spatially focused incidence of energy, for example with a focused laser beam or a focused beam of electromagnetic radiation onto a small spot.

The solvent vapor or the gaseous substances formed by the treatment of the eluate portion are preferably removed by means of a carrier gas. When all solvent has been converted to the gas phase and removed, the remaining residue of the eluate portion (rest of the eluate portion) is converted in a second step to the gas phase, for example by increasing the temperature, or the laser or microwave power. This can convert either the molecules thereof or fragments to the gas phase. The fragments can be formed, for example, by energy supply (heat, laser, microwave, etc.). For isotope analysis, it is important that the substance is converted quantitatively to the gas phase. In a subsequent conversion step, the molecules or fragments now present as gases can be converted to the simple gases required for the isotope analysis.

Advantageously, the gaseous conversion products, especially from the portion of the eluate portion which has not been evaporated and not been converted to gaseous fragments, are formed by at least one of the following steps:
a) combustion or pyrolysis,
b) conversion in a reactor,
c) laser action,
d) resonant energy injection by means of electromagnetic radiation,
e) non-resonant energy injection by means of electromagnetic radiation,
f) chemically selective conversion.

In this way, simple stable gases are formed, such as CO₂, N₂, CO, H₂, Cl₂, HCl, CH₄, SO₂ or other gases. The conversion to the simple stable gases can be effected, for example, by means of
reactors in which the gaseous substances react over metal oxides to give CO₂ and/or N₂ and/or SO₂,
reactors in which the gaseous substances are pyrolyzed at high temperatures to give H₂ and/or CO₂,
laser action, in which case the gaseous substances are converted to the stable simple gases by means of laser beams; in this case, an additional gas (e.g. O₂) or additive (for instance a metal oxide) which promotes the conversion (for instance to CO₂) can be added to the gaseous substances;
UV light, in which case the gaseous substances are converted by means of UV light and an additional gas or additive to the simple gases required (e.g. CO₂);
reactive gas which itself, or by excitation with a laser, converts the gaseous substances to simpler gases.

The evaporation of the solvent and the conversion of the rest of the eluate portion (with or without evaporation of the rest of the eluate portion) can be effected within the same apparatus unit. The individual process steps would then each be performed at the same site and merely successively in terms of time. Alternatively, different apparatus units are used for the evaporation on the one hand and the conversion on the other.

The substances converted to the simple gases can subsequently be supplied via a transfer unit to an isotope analyzer or isotope mass spectrometer. Such transfer units are known in principle; see ConFlo IV product from Thermo Electron Corporation, now known as Thermo Fisher Scientific.

In a further development of the invention, it is envisaged that the gaseous conversion products are entrained by a gaseous carrier fluid and supplied to the isotope analyzer. The gaseous carrier fluid may especially be an inert gas such as helium.

According to a further concept of the invention, the portion of interest from the eluate is collected on a substrate. It is also possible to take up the eluate portion in a chamber. The substrate may also be arranged in a chamber.

The processing of the eluate portion may involve evaporating the carrier fluid from the substrate. Subsequently, the unevaporated portion of the eluate portion can be combusted—oxidized or pyrolyzed. It is also possible to introduce the substrate with the eluate portion or with a portion of the eluate portion into a reactor to perform a combustion—oxidation or pyrolysis. The combustion in the reactor then forms the gaseous conversion products.

The substrate is advantageously a vessel with a cavity. The vessel may be plastically deformable and is preferably a capsule. However, other configurations of the substrate are also possible, for instance as a flat strip. After the collection of the eluate portion, a capsule can be closed by bending the walls together. A strip can be folded up, such that the eluate portion taken up is enclosed on all sides. The closure of the substrate or enclosure of the eluate portion can alternatively also be effected only after the evaporation of a portion of the eluate portion.

The substrate may consist of a wide variety of different materials, according to application and eluate, for instance of tin, polymer material or ceramic. Advantageous examples are tin foil, tin capsules with bendable walls, ceramic boats or, especially for the analysis of nitrogen, substrates based on hydrocarbons, for instance plastic strips.

In a further development of the invention, the processing of the eluate portion may involve separating gaseous conversion products of the analytes in a gas chromatography process.

Alternatively, the unevaporated portion of the eluate portion can also be washed off the substrate with another carrier fluid. Gaseous conversion products are formed from the liquid obtained in this way.

Evaporation of the eluate portion, of the processed eluate portion, of the carrier fluids and/or of the analytes can also be performed outside the reactor. It is also possible to evaporate a plurality of components with the same apparatus: a first heating stage is used to evaporate a carrier fluid and a second heating stage the analytes. The latter can optionally be supplied in the gas stream to a high-temperature reactor for combustion.

According to a further concept of the invention, only one isotope of two or more isotopes of one element, especially of an isotope pair, is analyzed, and the isotope ratio is determined by calculation, for instance on the basis of the chemical composition of the analyte or of the conversion products.

The inventive apparatus for isotope ratio analysis has the following features:
a) a liquid chromatograph, which may also be an HPLC and which releases an eluate which comprises one or more analytes,
b) a device connected downstream of the liquid chromatograph for taking up a portion of the eluate and optionally for evaporating a portion of the eluate portion taken up,
c) a reactor for evaporating and combusting or only for combusting the unevaporated portion of the eluate portion,
d) a source for the supplying of gaseous carrier fluid to the reactor,
e) an isotope analyzer, to which conversion products from the reactor can be supplied.

The device arranged downstream of the liquid chromatograph for taking up an eluate portion may be an autosampler. Such devices are known in a wide variety of different configurations and variations. The autosampler serves as a program-controlled holding and conveying device for the substrate. The eluate portion of interest can be released to the substrate, for example, by switching, especially under program control, between different lines at the outlet of the LC device. The control or regulation of the switching is preferably effected as a function of the passage of time in the liquid chromatography process or of the output signal of a detector assigned to the LC.

According to a further concept of the invention, the reactor is part of an element analyzer. This also contributes to a very substantially automated procedure. The volumes of reactor and/or element analyzer are preferably matched to the expected amounts of analyte.

In a further development of the invention, it is envisaged that the device arranged downstream of the LC for taking up the eluate portion has a carrier for a substrate which takes up the eluate portion, a heating device for heating the substrate or the eluate portion present thereon and a conveying device for moving the carrier from a position adjacent to the LC into a position adjacent to the reactor.

Process and apparatus according to the invention are preferably usable for analysis of foods, food additives, blood, plasma and urine. Target substances (analytes) are especially pharmaceuticals, metabolism products, steroids, proteins, peptides, amino acids, RNA/DNA, organic acids, pesticides and nitrates. A preferred application also consists in the determination of an isotope fingerprint, specifically in the isotope ratio analysis for more than one element, especially at least two elements from the elements carbon, oxygen, nitrogen, sulfur and hydrogen.

The isotope analyzer is preferably an IRMS or a laser absorption measurement device.

The invention also provides a process and an apparatus corresponding to the process mentioned and the apparatus mentioned, but without additionally containing the liquid chromatography process or the liquid chromatograph. The invention then relates only to the steps which follow the liquid chromatography process or to an apparatus which can be attached to a liquid chromatograph present. Of course, the abovementioned further developments of the particular invention may also relate to this process and this apparatus.

The invention also provides an apparatus for isotope ratio analysis comprising the following features:
a) comprising a liquid chromatograph, which may also be a high-performance liquid chromatograph (HPLC), and which releases an eluate which comprises one or more analytes,
b) comprising a first device (evaporator unit) connected downstream of the liquid chromatograph, for taking up a portion of the eluate and for selectively evaporating the constituents of the eluate portion,
c) comprising a second device (conversion unit) arranged especially downstream of the first device, for converting a portion of the eluate portion to one or more gaseous conversion products of the analyte(s),
d) with a transfer unit for transferring the conversion products to an isotope analyzer.

In the first device, in a first step the carrier fluid is evaporated, and in a second step the rest of the eluate portion. The latter contains the analyte(s), can be supplied to the second device and is converted there to the gaseous conversion products which are finally transferred into the isotope analyzer.

According to a further concept of the invention, it is envisaged that the first device (evaporator unit) and the second device (conversion unit) are combined in a single unit, in which both the evaporation of the carrier fluid present in the eluate portion and/or the evaporation of the rest of the eluate portion and the conversion of the rest of the eluate portion can be performed. In this way, the apparatus complexity is reduced.

### BRIEF DESCRIPTION OF THE DRAWINGS

Advantageous further developments of the invention are evident from the claims and from the rest of the description. Preferred working examples of the invention are explained in detail hereinafter with reference to drawings. The drawings show:

FIG. 1 is a schematic diagram of an inventive apparatus,

FIG. 2 is a modification of the apparatus according to FIG. 1,

FIG. 3 is the schematic structure of an inventive system, and

FIGS. 4 to 7 are the sequence of the individual steps in the generation of a simple gas for isotope analysis from an eluate portion.

### DETAILED DESCRIPTION OF PREFERRED EMBODIMENTS

In a liquid chromatograph 10, especially HPLC, a sample is subjected to a suitable chromatographic separation. A portion of the eluate obtained is collected on a suitable substrate 11. The collection of the eluate portion of interest is possible, for example, by program-controlled switching of a valve 12 in an outlet line 13 of the liquid chromatograph 10 which leads toward the substrate 11. Upstream of the valve 12, the outlet line 13 is connected to a waste line 14. The program control can be effected, for example, as a function of time or as a function of the output signal of a detector which is not shown, such that only the eluate portion of interest arrives at the substrate 11.

The chromatographic separation and the collection of the eluate portion of interest can also first be performed several times in succession. The eluate portion of interest is then collected, for example on the substrate 11 or before it reaches the latter.

On an autosampler 15, the substrate 11 can be moved under program control into a position 16 in which the solvent present in the eluate portion can evaporate. For this purpose, a heat source 17 can be provided at this position.

Subsequently, the substrate can be moved into a position 18 in which a transfer of the substrate with the residue of the eluate portion present thereon into a reactor 19 is possible. In the reactor 19, combustion or oxidation, or pyrolysis, takes place. The gases obtained are passed into an isotope analyzer 20. This is preferably an isotope mass spectrometer (IRMS).

Between reactor 19 and isotope analyzer 20, the gases obtained can be separated by an appropriate device, for instance by a gas chromatograph 21.

The substrates envisaged are, for example, tin capsules in which the eluate portion of interest is collected. The reactor 19 may be part of an element analyzer, for example of the Finnigan TC/EA type. It is advantageous to adjust the apparatus to the relatively small amounts of sample by reducing or scaling down the volumes in the apparatus.

The substrate 11 may also be configured in the manner of a strip. The eluate portion is collected on the strip, the solvent present in the eluate portion is evaporated and the rest is supplied to the reactor 19. In the isotope analysis of nitrogen, the strip may consist, for example, of hydrocarbons instead of tin.

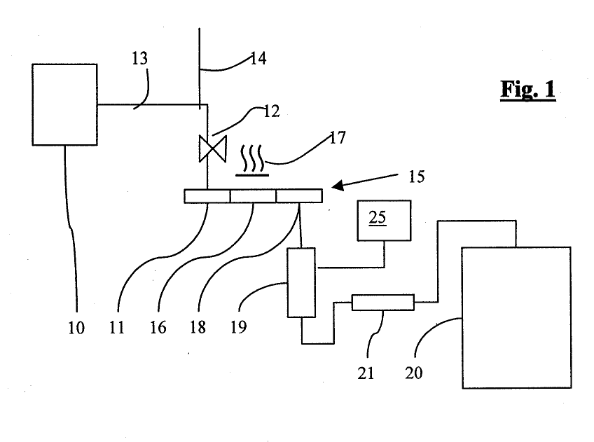

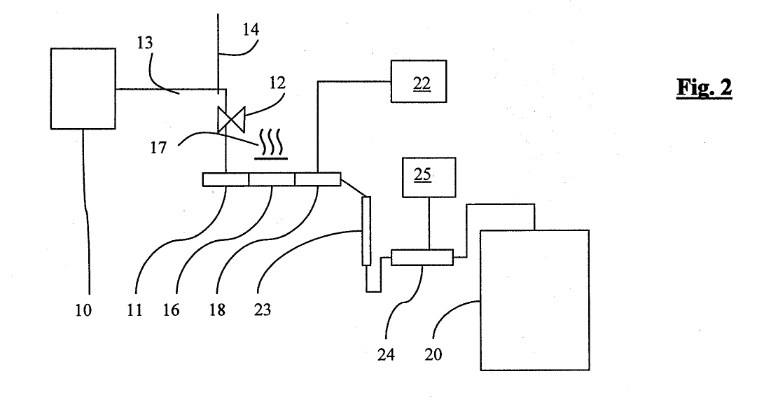

One modification of the apparatus is shown in FIG. 2. In contrast to FIG. 1, a solvent source 22 with a flushing apparatus not shown in detail is assigned to the position 18 of the substrate. In position 16, the solvent of the liquid chromatograph 10 is evaporated. In position 18, the residue on the substrate is washed off by a suitable solvent and optionally supplied to a device 23 for cleaning or concentrating, before the eluate portion processed in this way is processed further to form one or more gaseous conversion products of the analytes in an appropriate device 24. This may, for example, be an element analyzer, a reactor, an electrolysis device or another device for generating the desired conversion products. At the end of the chain is again the isotope analyzer 20.

A carrier gas source 25 is assigned to the reactor 19 in FIG. 1. By virtue of the carrier gas flow, the gaseous conversion products pass into the gas chromatograph 21 or directly into the isotope analyzer 22. Analogously, in FIG. 2, the carrier gas source 25 is assigned to the device 24.

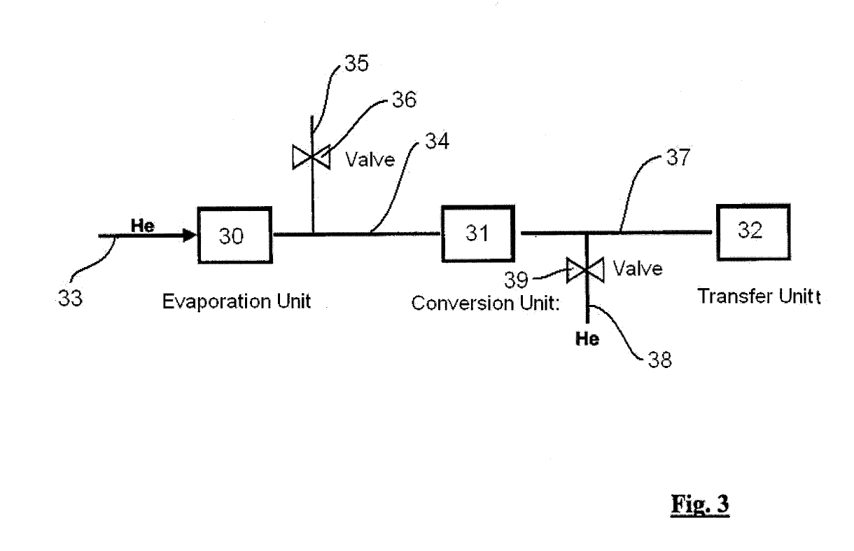

Embodiments in which a substrate need not necessarily be used are explained hereinafter with reference to FIGS. 3 to 7. According to FIG. 3, an evaporator unit 30, a conversion unit 31 and a transfer unit 32 are arranged in succession.

An eluate portion from a liquid chromatograph is supplied together with a carrier gas (e.g. helium) via a line 33 to the evaporator unit 30. It is also possible to supply the eluate portion via a separate line in the evaporator unit 30.

In the evaporator unit, energy is supplied to the eluate portion, for instance by a heater, a laser device, a microwave device or a device for releasing electromagnetic radiation for resonant heating in particular. Also possible is non-resonant heating. In addition, the addition of a reacting substance may be provided in the evaporator unit, for instance for chemically selective etching to evaporate the solvent and/or the rest of the eluate portion (freed of the solvent).

Evaporator unit 30 and conversion unit 31 are connected to one another by a line 34, from which a purge or waste line 35 departs. The latter is provided with a purge or waste valve 35. With the valve 35 open, the gases obtained in the evaporator unit 30 can be removed via the line 35.

The gases comprising the analyte pass into the conversion unit 31 and are converted there to simple gases. To this end, the conversion unit may have a heating device, a laser device, a microwave device, a device for releasing electromagnetic radiation and/or a device for chemically selective etching, for instance by supplying a further substance.

From the conversion unit 31, the simple gases obtained pass through a line 37 into the transfer unit 32. Connected to the line 37 is a line 38 for the supply of carrier gas, especially helium. The line 38 can be shut off by a valve 39.

The transfer unit establishes the connection to the isotope analyzer which is not shown, for instance to an isotope mass spectrometer. The transfer unit used may, for example, be the ConFlo IV device supplied by Thermo Electron Corporation.

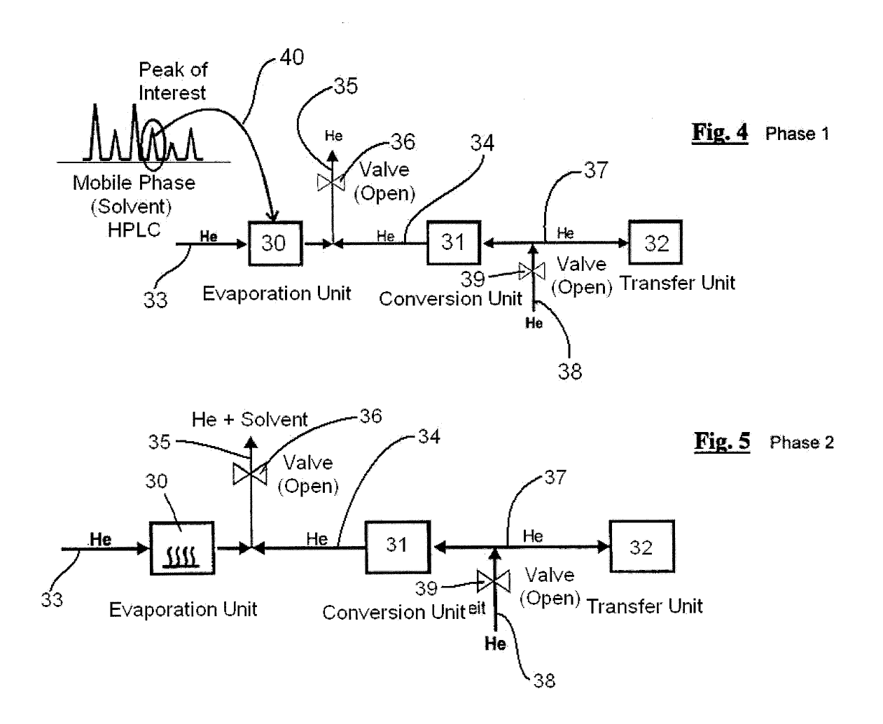

FIGS. 4 to 7 build on one another and show phases 1 to 4 of the processing of a substance to be analyzed for isotope analysis.

In phase 1 (FIG. 4), a section of interest from the eluate of an HPLC, an eluate portion, is supplied to the evaporator unit 30. In this phase, the valves 36 and 39 should be open. The eluate portion is supplied to the evaporator unit 30 via a line 40.

In phase 2 (FIG. 5), the solvent is evaporated out of the eluate portion and conducted out of the process via line 35. For this purpose, the valves 36, 39 are open and a carrier gas or purge gas, preferably helium, is supplied first via line 33 and secondly via line 38, such that the gaseous solvent obtained in the evaporator unit 30 can flow out only via line 35 and does not pass, for example, into the conversion unit 31.

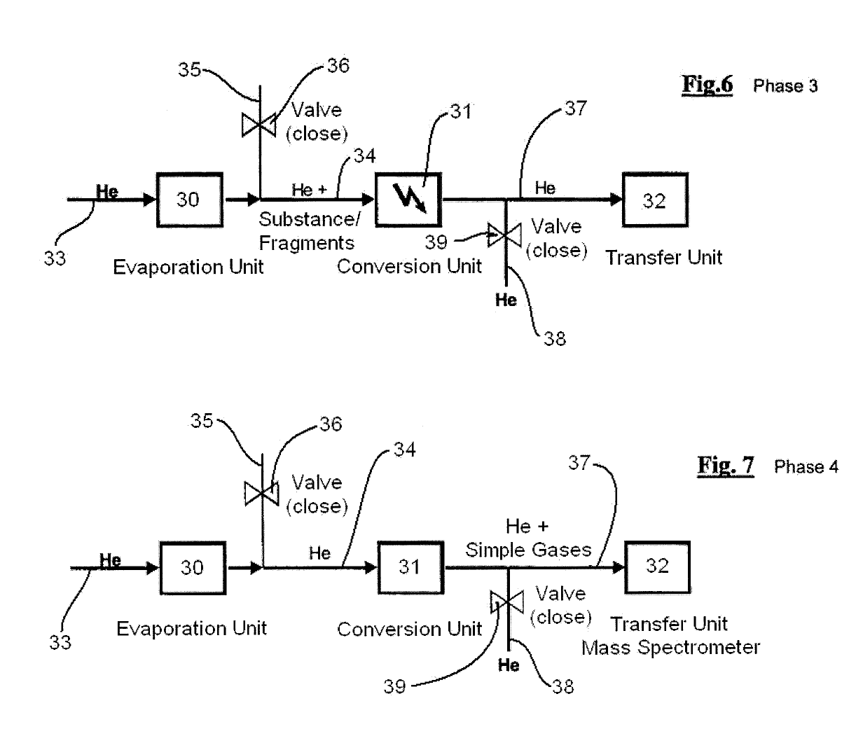

In phase 3 (FIG. 6), in the evaporator unit 30, the residue of the eluate portion which has been freed of the solvent is also converted to gaseous form, especially by further heating. This can also form gaseous fragments. The valves 36 and 39 are closed. Carrier gas or purge gas flows in via line 33, such that the gas flows out of the evaporator unit 30 into the conversion unit 31. In the conversion unit 31, a conversion of the gases to the simple gases required for the analysis takes place. These simple gases are preferably H₂, CO, CO₂, N₂, Cl₂, HCl, CH₄ and/or SO₂. Other gases are also possible.

In phase 4 (FIG. 7), the valves 36, 39 are still closed. The simple gases obtained in the conversion unit 31 are conducted with the carrier gas or purge gas stream into the transfer unit 32 and from there to the mass spectrometer which is not shown.

The transitions from phase 1 to phase 2 and from phase 3 to phase 4 are preferably continuous, as a result of the gas streams and valve settings.

Evaporator unit 30 and conversion unit 31 can also be combined in one unit, especially when evaporation and conversion are to be performed by the same means, for instance by heating with an electrical resistance heater.

### LIST OF REFERENCE NUMERALS

10 Liquid chromatograph
11 Substrate
12 Valve
13 Outlet line
14 Waste line
15 Autosampler
16 Position of the substrate
17 Heat source
18 Position of the substrate
19 Reactor
20 Isotope analyzer
21 Gas chromatograph
22 Solvent source
23 Device for cleaning/concentrating
24 Device
25 Gas source
30 vaporation unit
31 Conversion unit
32 Transfer unit
33 Line
34 Line

What is claimed is:

1. A process for isotope ratio analysis, comprising the steps of:
a) performing a liquid chromatography process and thus providing an eluate which comprises at least one liquid carrier fluid and at least one analytes,
b) collecting a portion of interest from the eluate,
c) processing the eluate portion to form at least one gaseous conversion products of the at least one analytes, and
d) supplying the gaseous conversion products, with gaseous carrier fluid, to an isotope analyzer.

2. The process as claimed in claim 1, wherein the processing of the eluate portion involves evaporation of the carrier fluid or conversion thereof to gaseous fragments.

3. The process as claimed in claim 1, wherein the carrier fluid is evaporated or the carrier fluid is converted to gaseous fragments by at least one of the following steps:
a) heating the eluate portion,
b) laser action,
c) resonant energy injection by means of electromagnetic radiation,
d) non-resonant energy injection by means of electromagnetic radiation, and
e) chemically selective conversion.

4. The process as claimed in claim 1, wherein the evaporated carrier fluid or the gaseous fragments thereof are entrained and removed by a carrier gas.

5. The process as claimed in claim 1, wherein the gaseous conversion products are formed from the portion of the eluate portion which has not been evaporated and has not been converted to gaseous fragments, by at least one of the following steps:
a) combustion or pyrolysis,
b) conversion in a reactor,
c) laser action,
d) resonant energy injection by means of electromagnetic radiation,
e) non-resonant energy injection by means of electromagnetic radiation, and
f) chemically selective conversion.

6. The process as claimed in claim 5, wherein the gaseous conversion products are entrained by a gaseous carrier fluid and supplied to the isotope analyzer.

7. The process as claimed in claim 1, wherein the portion of interest from the eluate is collected on a substrate.

8. The process as claimed in claim 7, wherein the processing of the eluate portion involves evaporating the carrier fluid from the substrate, and in that the unevaporated portion of the eluate portion is subsequently combusted—oxidized or pyrolyzed.

9. The process as claimed in claim 7, wherein the substrate (11) with the eluate portion or with a portion of the eluate portion is introduced into a reactor (19) to perform a combustion—oxidation or pyrolysis—and in that the combustion in the reactor forms gaseous conversion products of the analytes.

10. The process as claimed in claim 7, wherein the substrate (11) is a vessel with a cavity.

11. The process as claimed in claim 10, wherein the substrate (11) is a capsule, a film or a strip.

12. The process as claimed in claim 7, wherein the substrate (11) is a tin foil, a tin capsule, a plastic strip or a ceramic boat.

13. The process as claimed in claim 1, wherein the substrate (11) consists of tin or of hydrocarbons.

14. The process as claimed in claim 1, wherein the processing of the eluate portion involves separating gaseous conversion products of the analytes in a gas chromatography process.

15. The process as claimed in claim 7, wherein the processing of the eluate portion involves evaporating the carrier fluid from the substrate, in that the unevaporated portion of the eluate portion is washed off the substrate with another carrier fluid, in that a purification or concentration of the liquid—other carrier fluid with unevaporated eluate portion—is then optionally carried out, and in that gaseous conversion products are finally formed.

16. The process as claimed in claim 1, further comprising the isotope analysis of nitrogen.

17. The process as claimed in claim 1, wherein only one isotope is analyzed for a selected element and the ratio of this isotope to at least one other isotope is determined by calculation.

18. An apparatus for isotope ratio analysis, comprising:
a) a liquid chromatograph (10) which releases an eluate which comprises at least one analytes,
b) a device connected downstream of the liquid chromatograph for taking up a portion of the eluate and optionally for evaporating a portion of the eluate portion taken up,
c) a reactor (19) for evaporating a portion of the eluate portion and combusting the rest of the eluate portion, or only for combusting the unevaporated portion of the eluate portion,
d) a source for the supplying of gaseous carrier fluid to the reactor, and
e) an isotope analyzer (20), to which conversion products from the reactor (19) can be supplied.

19. The apparatus as claimed in claim 18, wherein the device arranged downstream of the liquid chromatograph (10) for taking up the eluate portion is an autosampler (15).

20. The apparatus as claimed in claim 18, wherein the reactor (19) is part of an element analyzer.

21. The apparatus as claimed in claim 18, wherein the device arranged downstream of the liquid chromatograph (10) for taking up the eluate portion has a carrier for a substrate (11) which takes up the eluate portion, a heating device for heating the substrate or the eluate portion present thereon and a conveying device for moving the carrier from a position adjacent to the liquid chromatograph (10) into a position adjacent to the reactor (19).

22. A process for isotope ratio analysis, comprising the steps of:
a) collecting a portion of interest from an eluate from a liquid chromatography process, said eluate comprising at least one liquid carrier fluid and at least one analytes,
b) processing the eluate portion to form at least one gaseous conversion products of the at least one analytes,
c) supplying the at least one gaseous conversion products, with gaseous carrier fluid, to an isotope analyzer and determining the isotope ratios therein.

23. An apparatus for isotope ratio analysis, comprising:
a) a device for taking up a portion of the eluate from a liquid chromatograph, said eluate comprising at least one analytes, and for evaporating a portion of the eluate portion taken up,
b) a reactor (19) for obtaining conversion products by combusting the unevaporated portion of the eluate portion,
c) a source for the supplying of gaseous carrier fluid to the reactor, and
d) an isotope analyzer (20), to which the conversion products of the reactor (19) can be supplied.

24. An apparatus for isotope ratio analysis, comprising:
a) a liquid chromatograph (10) which releases an eluate which comprises at least one analytes,
b) a first device (evaporator unit) connected downstream of the liquid chromatograph (10), for taking up a portion of the eluate and for selectively evaporating constituents of the eluate portion,
c) a second device (conversion unit) arranged especially downstream of the first device, for converting a portion of the eluate portion to at least one gaseous conversion products of the at least one analyte(s), and
d) a transfer unit for transferring the conversion products to an isotope analyzer.

25. The apparatus as claimed in claim 24, wherein the first device (evaporator unit) and the second device (conversion unit) are combined in a single unit in which both the evaporation and the conversion can be performed.
